(19) United States
(12) Patent Application Publication
(10) Pub. No.: US 2003/0037440 A1
(43) Pub. Date: Feb. 27, 2003

(54) Coring device

(75) Inventor: David Raz, Sha'ray Tikva (IL)

Correspondence Address: DARBY & DARBY P.C., 805 Third Avenue, New York, NY, 10022, US

(73) Assignee: Erato Enterprises, Inc.

(21) Appl. No.: 09/934,326

(22) Filed: Aug. 21, 2001

(51) Int. Cl. A47J 23/00; B26B 27/00

(52) U.S. Cl. 30/113.1; 30/113.3

(57) ABSTRACT

Apparatus for creating cavities in edible material includes a cylindrical hollow tube having a distal end that is adapted to serve as a cutting edge and a core removal blade extending inward from the cutting edge part way across the tube.

### FIELD OF THE INVENTION

The present invention relates generally to food preparation, and specifically to mechanical means for removing the cores of, or placing a cavity in, various fruits, vegetables and other edibles.

### BACKGROUND OF THE INVENTION

Various devices have been designed for removing the cores of fruits, vegetables and other edibles, both in bulk and on an individual basis. A number of these devices have been designed to be used in large scale food service operations, such as institutional kitchens. Others have been designed for use in the home and by small food service operations.

U.S. Pat. No. 1,390,977 to Behr, which is incorporated herein by reference, describes a handheld, spring-operated device for removing pits from cherries.

U.S. Pat. No. 3,586,081 to Ellis et al., which is incorporated herein by reference, describes a device for peeling and coring apples that have been picked from a bulk supply. U.S. Pat. Nos. 3,869,974 and 3,962,963 to Ellis, which are incorporated herein by reference, disclose methods of further processing apples which have been oriented, peeled and cored on the machine described in U.S. Pat. No. 3,586,081. In accordance with the technique described in these patents, the fibrous carpel tissue providing the seed cell in the apple is removed and the apples may be discharged whole or passed through a slicing device to cut the apples into a number of segments.

U.S. Pat. No. 5,056,223 to Buck et al., which is incorporated herein by reference, describes a hand tool that is shaped and sized to separate a core from the leaves of a cabbage head and to remove the separated core from the leaves.

U.S. Pat. No. 5,699,725 to Poltielov, which is incorporated herein by reference, discloses a tool for preparing baked apples and other fruits and vegetables by coring through the top of each fruit or vegetable to form a hole therein. The tool includes a hollow plug cutter barrel, which is rotated as it is pressed down against the fruit, thus cutting into the fruit around the core. In one embodiment, the hollow plug cutter barrel has a crossbar extending completely across its opening at the cutting end, whose function is to dislodge the core.

U.S. Pat. No. 6,148,719 to Poltielov, which is incorporated herein by reference, describes a device, for mechanically removing the cores of fruits and vegetables. The device is designed to be used with a vertical or horizontal hand press.

U.S. Pat. No. 4,903,407 to Fischer, which is incorporated herein by reference, describes a device for preparing comestibles, such as fruits, vegetables, cold meats and cheese, by making a cavity in these items to allow one to fill these with another edible material.

### SUMMARY OF THE INVENTION

It is an object of some aspects of the present invention to provide simple and easily-insertable apparatus for removing a core from fruits and vegetables.

It is a further object of some aspects of the present invention to provide apparatus to create cavities in comestibles including fruits and vegetables, pastries, cakes, cold meat and cheese, in which the resulting plug is easily removed at the end of the operation.

In preferred embodiments of the present invention, apparatus for coring fruits and vegetables and creating a cavity in a food item comprises a cylindrical extended hollow cutting element attached to a handle at one end, and comprising, at its other end: (a) a cutting edge, preferably serrated, around the periphery of the hollow element, and (b) a core removal blade, attached to the periphery of the hollow element perpendicular to the axis of the element, and extending inward toward the axis. In distinction to the crossbar shown in the above-mentioned U.S. Pat. No. 5,699,725 to Poltielov, the core removal blade extends only part way across the cylinder, preferably no more than half way.

An operator holding the handle pushes the apparatus into the food item while rotating the handle. Upon reaching the desired depth, the operator pulls the apparatus out of the food item along with the material captured in it. The perpendicular core removal blade, having cut a generally spiral path through the core during the rotation and insertion of the apparatus into the food item, subsequently serves as a base to support the removal of the core as the hollow element is withdrawn from the item. In a simple operation, therefore, these preferred embodiments of the present invention core a fruit or vegetable, or create a cavity in a food item and remove the excess material contained within the cavity. Because the core removal blade extends only part way across the cylinder, it is easy to insert the cutting element into the food item by hand (unlike Poltielov's device, which require special presses or power attachments), but still removes the entire core neatly and efficiently.

There is therefore provided, in accordance with a preferred embodiment of the present invention, apparatus for creating cavities in edible material, including:

a cylindrical hollow tube having a distal end that is adapted to serve as a cutting edge; and

a core removal blade extending inward from the cutting edge part way across the tube.

Preferably, the apparatus includes a handle fixed to a proximal end of the tube. Additionally or alternatively, the cutting edge is serrated, and a segment of the length of the cylindrical hollow tube is not fully enclosed by the periphery of the tube.

Preferably, the core removal blade extends inward no more than half way across the hollow tube, and most preferably substantially less than half way across the hollow tube. Further preferably, the core removal blade is generally perpendicular to a longitudinal axis of the cylindrical hollow tube.

There is also provided, in accordance with a preferred embodiment of the present invention, a method for creating cavities in edible material, including:

bringing a cylindrical hollow tube, having a distal end that is adapted to serve as a cutting edge and a core removal blade extending inward from the cutting edge part way across the tube, into contact with a surface of the edible material;

pressing the tube into the material while rotating the tube, so as to make a generally cylindrical cut through the material; and

when the cut reaches a desired depth in the material, withdrawing the tube so as to pull out a portion of the material that is within the tube.

Preferably, the tube is inserted by grasping and turning a handle fixed to a proximal end of the tube, so that the core removal blade incises a spiral into the material within the tube.

The present invention will be more fully understood from the following detailed description of the preferred embodiments thereof, taken together with the drawings, in which:

### BRIEF DESCRIPTION OF THE DRAWINGS

FIG. 1 is a schematic perspective illustration of apparatus for coring a food item, in accordance with a preferred embodiment of the present invention;

FIG. 2 is a schematic illustration of the distal end of the apparatus shown in FIG. 1, showing a plane perpendicular to the axis of the apparatus; and

FIG. 3 is a schematic illustration of a cross-section of the distal end of the apparatus shown in FIG. 1, showing a plane parallel to the axis of the apparatus.

### DETAILED DESCRIPTION OF PREFERRED EMBODIMENTS

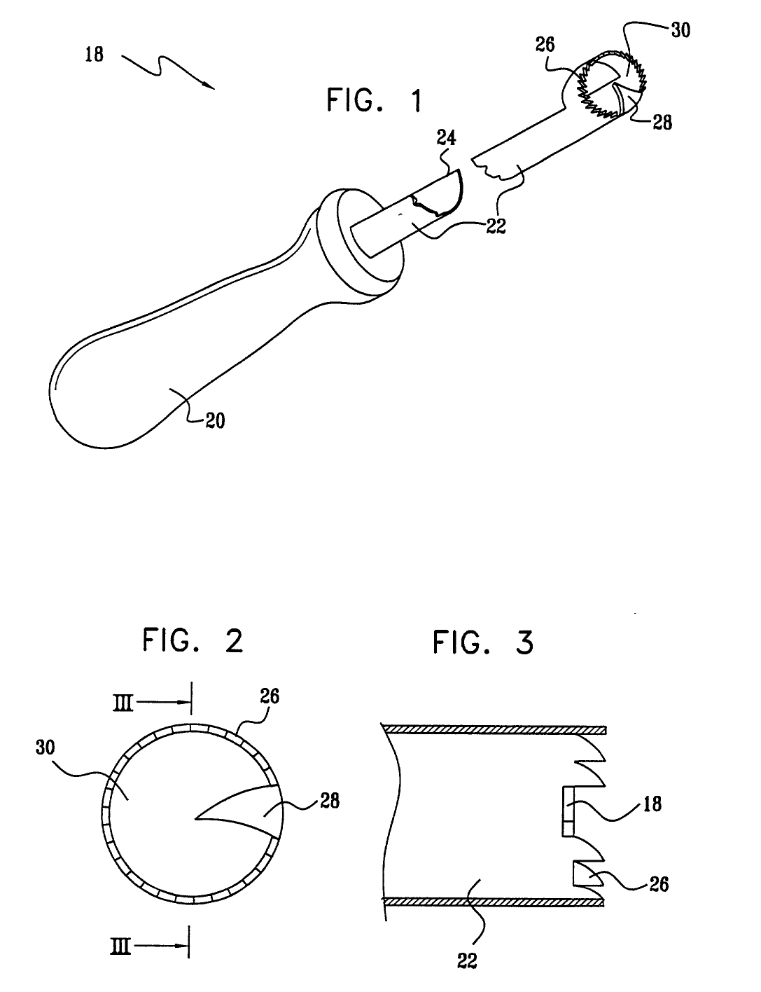

FIG. 1 is a schematic sectional illustration of apparatus 18 for coring a food item, in accordance with preferred embodiments of the present invention. Apparatus 18 typically comprises a handle 20 at its proximal end, and a hollow cylindrical element 22 at its distal end. Preferably, cylindrical element 22 is not fully enclosed by its periphery for a portion 24 of its length, so as to allow easy removal of an extracted core, and to facilitate cleaning of the apparatus after use. Distal to portion 24, hollow element 22 preferably forms a complete ring. A serrated edge 26, which is typically cut out of element 22, extends forward, to be placed against the food item. A perpendicular core removal blade 28, also preferably cut out of element 22, extends partially into an enclosed space 30 defined by the distal end of element 22.

Reference is now made to FIGS. 2 and 3, which are schematic illustrations of the distal end of apparatus 18, in accordance with a preferred embodiment of the present invention. FIG. 2 is an end view in a plane perpendicular to a longitudinal axis of element 22, and FIG. 3 is a cross-sectional view in a plane parallel to the axis of element 22. Core removal blade 28 extends from the rim of element 22 into space 30.

In use, apparatus 18 is placed by an operator holding handle 20 into a position adjacent to the surface of an item of food. The operator rotates apparatus 18 while applying pressure, thereby enabling serrated edge 26 to cut and penetrate into the item. Simultaneously, blade 28 cuts a spiral pattern into the portion of the food within space 30. Upon reaching the desired distance into the food item, the operator pulls handle 20, and apparatus 18 is withdrawn from the food item. During withdrawal, cutting edge 28 pushes the material captured within the circumference of apparatus 18 (e.g., the core of a fruit), until the material is entirely removed from the food item. Thus, in a simple operation, this preferred embodiment of the present invention removes the core of a fruit or vegetable, or creates a cavity in a food item and removes the material contained within the cavity. Typically, the cavity is then filled with an appropriate stuffing.

Devices in accordance with preferred embodiments of the present invention may be made in different sizes and with different cutting characteristics, depending on the specific intended application. For example, element 22 may be made of different types of materials, and with different sizes and types of serrations, or with a smooth cutting edge. Furthermore, although apparatus 18 is operated manually, using handle 20, element 22 may also be adapted for mounting on a hand press or power drive. It will thus be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus for creating cavities in edible material, comprising:
a cylindrical hollow tube having a distal end that is adapted to serve as a cutting edge; and
a core removal blade extending inward from the cutting edge part way across the tube.

2. Apparatus according to claim 1, and comprising a handle fixed to a proximal end of the tube.

3. Apparatus according to claim 1, wherein the cutting edge is serrated.

4. Apparatus according to claim 1, wherein a segment of the length of the cylindrical hollow tube is not fully enclosed by the periphery of the tube.

5. Apparatus according to claim 1, wherein the core removal blade extends inward no more than half way across the hollow tube.

6. Apparatus according to claim 5, wherein the core removal blade extends inward substantially less than half way across the hollow tube.

7. Apparatus according to claim 1, wherein the core removal blade is generally perpendicular to a longitudinal axis of the cylindrical hollow tube.

8. A method for creating cavities in edible material, comprising:
bringing a cylindrical hollow tube, having a distal end that is adapted to serve as a cutting edge and a core removal blade extending inward from the cutting edge part way across the tube, into contact with a surface of the edible material;
pressing the tube into the material while rotating the tube, so as to make a generally cylindrical cut through the material; and
when the cut reaches a desired depth in the material, withdrawing the tube so as to pull out a portion of the material that is within the tube.

9. A method according to claim 8, wherein pressing the tube comprises inserting the tube by grasping and turning a handle fixed to a proximal end of the tube.

10. A method according to claim 8, wherein pressing the tube comprises inserting the tube so that the core removal blade incises a spiral into the material within the tube.

11. A method according to claim 8, wherein the core removal blade extends inward no more than half way across the hollow tube.

12. A method according to claim 11, wherein the core removal blade extends inward substantially less than half way across the hollow tube.
